(19) United States
(12) Patent Application Publication
(10) Pub. No.: US 2012/0129402 A1
(43) Pub. Date: May 24, 2012

(54) RECEPTACLE CONNECTOR HAVING CONTACT MODULES AND PLUG CONNECTOR HAVING A PADDLE BOARD

(75) Inventors: CHIEN-CHIUNG WANG, New Taipei (TW); QING-MAN ZHU, Kunshan (CN); XUE-LIANG ZHANG, Kunshan (CN)

(73) Assignee: HON HAI PRECISION INDUSTRY CO., LTD., New Taipei (TW)

(21) Appl. No.: 13/302,153

(22) Filed: Nov. 22, 2011

(30) Foreign Application Priority Data
Nov. 22, 2010 (CN) 201020617704.0

(51) Int. Cl. H01R 24/28

(52) U.S. Cl. 439/629

(57) ABSTRACT

A connector assembly has a receptacle connector and a plug connector adapted for inserting in the receptacle connector. The receptacle connector (100) includes housing (140), a first terminal (162) and a second terminal (164) secured in the housing. The second terminal is lower than the first terminal. The plug connector includes a paddle board (200) having a first conductive member (242) and a second conductive member (244). The second conductive member is higher than the first member. The first terminal contacts with the first conductive member, and the second terminal contacts with the second conductive member. The paddle board is capable of inserting into the housing easily and protecting the terminals and the paddle board.

### BACKGROUND OF THE INVENTION

1. Field of the Invention

The present invention relates to a receptacle connector and a plug connector, and more particularly to a SFP (Small Form-Factor Pluggable) receptacle connector and a plug connector mating with the receptacle connector. The application relates to the copending application Ser. No. 13/210,601 filed Aug. 16, 2011 having the same assignee with the invention.

2. Description of Related Art

U.S. Pat. No. 7,798,820 issued to Hong on Sep. 21, 2010 discloses a receptacle connector comprising an inserting slot for insertion of a plug, a first and a second terminals disposed at a lower side of the insertion slot and aligned with each other along a mating direction. The first terminals are disposed in front of the second terminals at the inserting direction. A paddle board of the mating plug has an upper face, a row of first pads and a row of second pads disposed at the upper face and aligned with each other along the mating direction. The first pads are disposed in front of the second pads at the inserting direction. The first and the second pads are arranged at a same horizontal face. The first terminals contact with the first pads, and the second terminals contact with the second pads. U.S. Pat. Nos. 5,730,609, 6,368,129 and 6,402,556 also disclose two rows of terminals in a receptacle connector for contacting with two rows of pads on a paddle board.

In these prior arts, the contact portions of a first and a second terminals are aligned with each other, and a first and a second pads are arranged at a same horizontal face. When the paddle board is inserted in the inserting slot, the second terminals contact with the first pads firstly. In further insertion, the second terminals engage with the paddle board. The second terminals may cause damage to the board or break themselves. The paddle board may also experience difficulty in inserting into the receptacle connector.

Hence, a receptacle connector having improved contact modules and a mating plug having a paddle board is desired.

### SUMMARY OF THE INVENTION

Accordingly, an object of the present invention is to provide a receptacle and a plug connector mating easily with each other, and keeping close fit between the terminals and the pads without damaging the paddle board or contact portions of the terminals.

In order to achieve the object set forth, the invention provides a receptacle connector and a plug connector inserting in the receptacle connector along an inserting direction. The receptacle connector comprises a housing defining an inserting slot and a cavity communicating with the inserting slot, a row of first terminals received in the cavity and secured in the housing, and a row of second terminals received in the cavity and secured in the housing. Each of the first terminals has a first contact portion for mating with the paddle board, and each of the second terminals has a second contact portion for mating with the paddle board. The first contact portions and the second contact portions are disposed at a first side of the inserting slot. The first contact portions are disposed in front of the second terminal at the inserting direction, and higher than the second contact portions at another direction perpendicular to the inserting direction.

The plug connector comprises a paddle board having a first side, a second side and a mating edge. A row of first conductive members and a row of second conductive members are arranged at the first side. The first conductive members are closer to the mating edge than the second conductive members. The second conductive members are higher than the first conductive members along a direction from the second side to the first side.

The second contact portions are lower than the first contact portions, and the second conductive members are higher than the first conductive members. Therefore, the paddle board is capable of inserting easily into the housing without engaging with the second terminals and protecting the terminals and the paddle board.

Other objects, advantages and novel features of the invention will become more apparent from the following detailed description when taken in conjunction with the accompanying drawings.

### BRIEF DESCRIPTION OF THE DRAWINGS

FIG. 1 is a perspective view showing a housing of a receptacle connector and a paddle board of a plug connector in accordance with a first embodiment of the present invention;

FIG. 2 is another perspective view similar to FIG. 1, taken from another aspect;

FIG. 3 is a top view of the paddle board shown in FIG. 1;

FIG. 4 is a bottom view of the paddle board shown in FIG. 1;

FIG. 5 is a perspective view of the housing shown in FIG. 1;

FIG. 6 is an exploded view of the housing shown in FIG. 5;

FIG. 7 is a cross-sectional view showing the paddle board partially inserted into the housing, taken along line 7-7 of FIG. 1;

FIG. 8 is a cross-sectional view showing the paddle board inserted completely in the housing, taken along line 7-7 of FIG. 1;

FIG. 9 is a perspective view showing a paddle board in accordance with a second embodiment;

FIG. 10 is an exploded view showing a paddle board in accordance with a third embodiment; and

FIG. 11 is a cross-sectional view of the paddle board shown in FIG. 10.

### DETAILED DESCRIPTION OF THE PREFERRED EMBODIMENT

Reference will now be made in detail to the preferred embodiment of the present invention.

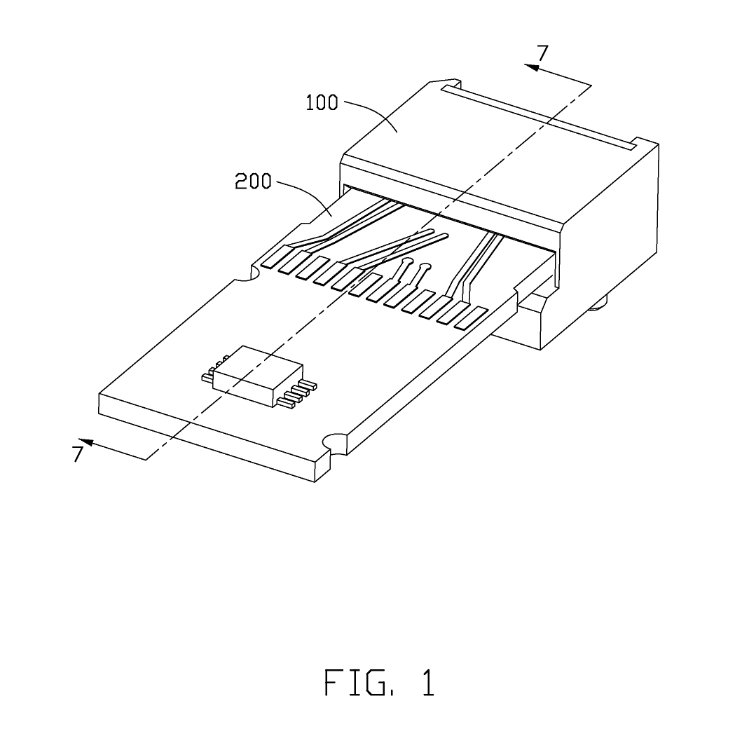

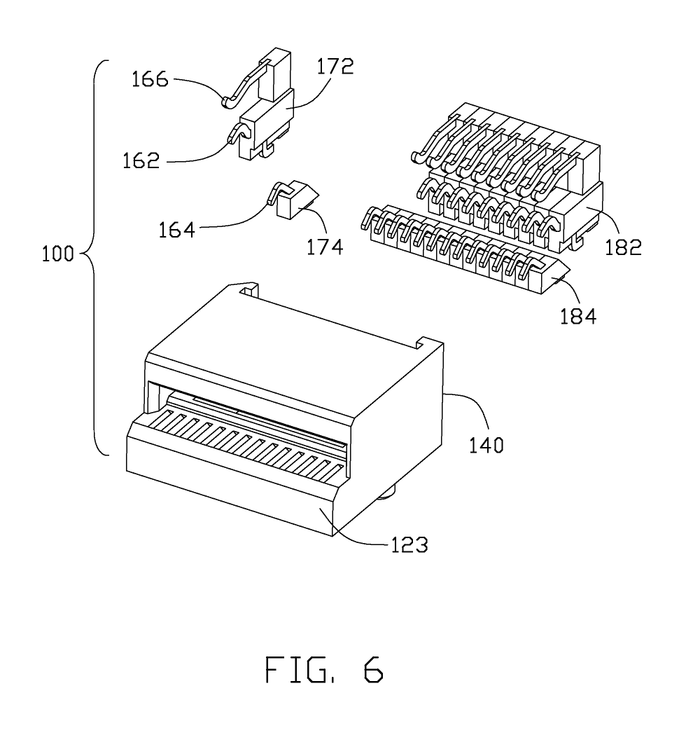

Referring to FIGS. 1-8, a connector assembly according to a first embodiment of the present invention is shown. The connector assembly includes a receptacle connector and a plug connector adapted for mating with the receptacle connector. The receptacle connector includes a receptacle 100, and a shielding cage (not shown) attached to the receptacle 100. The plug connector includes a top shell (not shown), a bottom shell (not shown), a recess (not shown) defined by the two shells, and a paddle board 200 received in the recess. In order to better show the present invention, only the paddle board 200 and the receptacle 100 are shown in the figures.

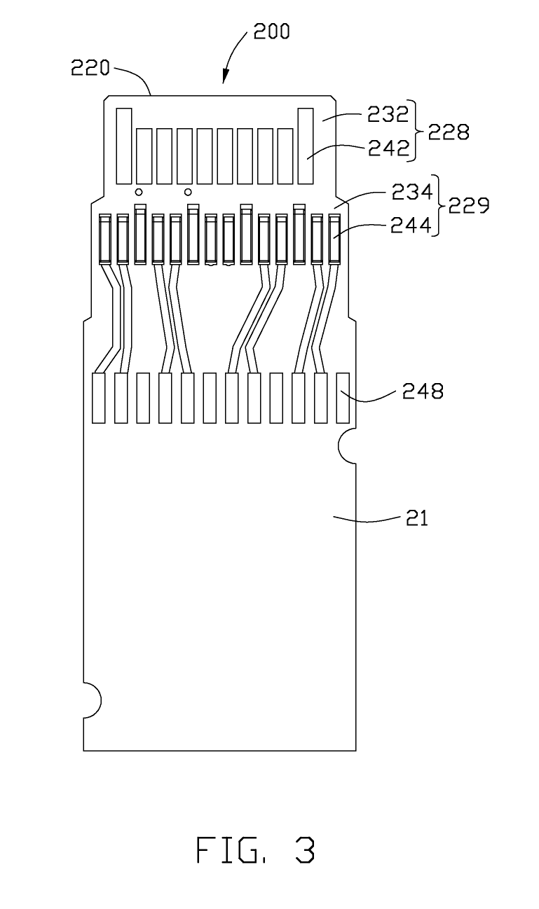

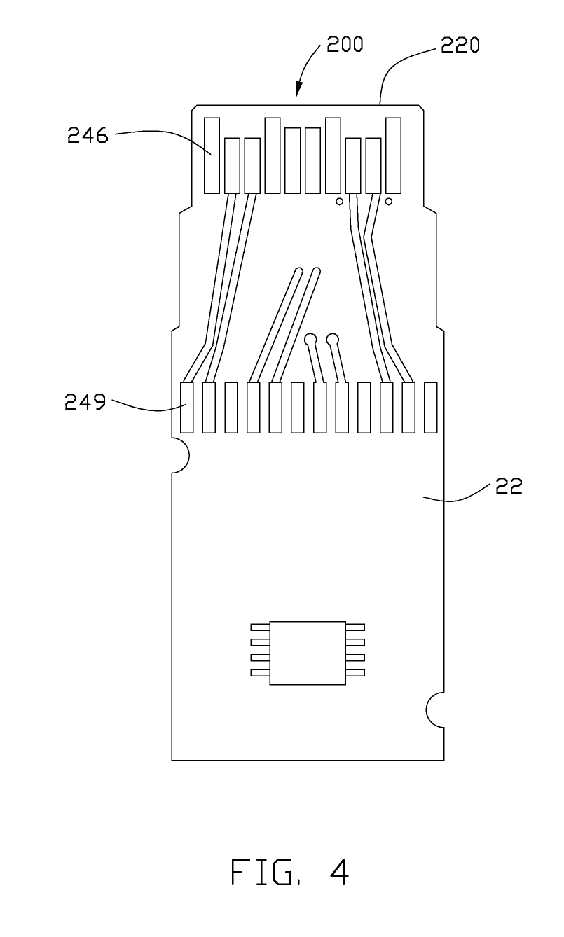

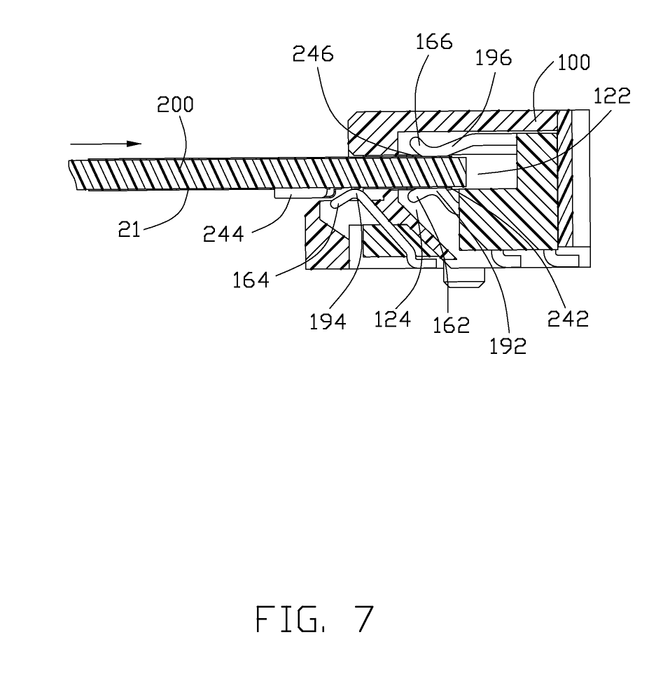

Referring to FIGS. 3 to 4, the paddle board 200 is a print circuit board. The paddle board 200 has a first side 21, a second side 22 and a mating edge 220. The paddle board 200 has a first mating face 228 and a second mating face 229 at the first side 21. The first mating face 228 is closer to the mating edge 220 than the second mating face 229. The paddle board 200 has a row of first conductive pads 242 arranged on first mating face 228, and a row of second conductive pads 244 arranged on the second mating face 229. The paddle board 200 also has a row of third conductive pads 246 arranged at the second side 22 and adjacent to the mating edge 220. The row of first conductive pads 242 are separated from each other by a first insulative layer 232. The row of second conductive pads 244 are separated from each other by a second insulative layer 234. The second conductive pads 244 are higher than the first conductive pads 242 along a direction from the second side 22 to the first side 21. The paddle board 200 also has two rows of cable pads 248, 249 arranged behind these conductive pads 242, 244, 246 for electrically connecting the conductive pads 242, 244, 246 to the cable (not shown). These conductive pads 242, 244, 246 for mating with the receptacle 100 are capable of transmitting signal or grounding. As best shown in FIG. 7, the second conductive pads 244 are thicker than the first conductive pads 242.

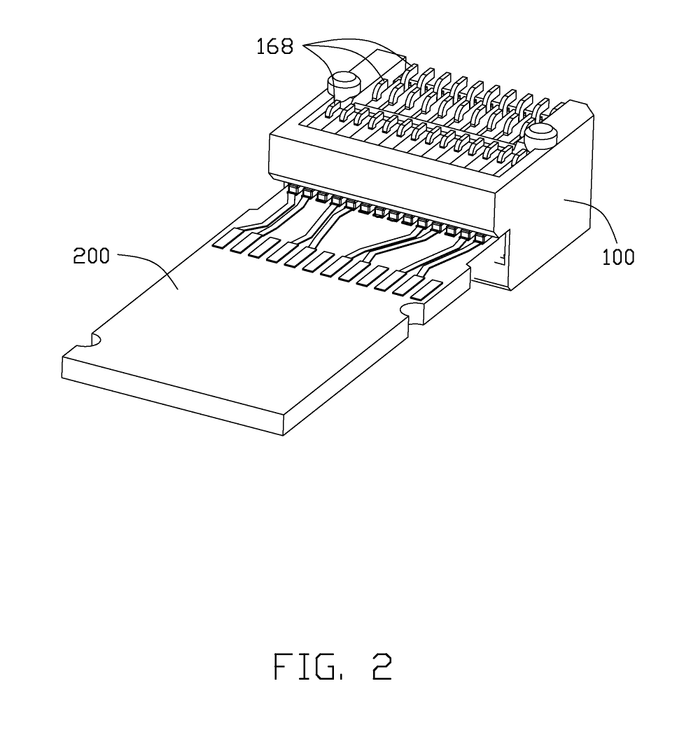

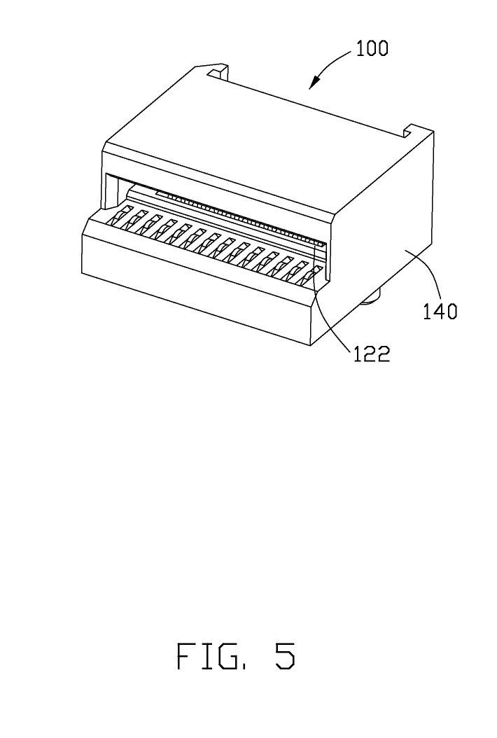

Referring to FIGS. 5-7, the receptacle 100 has a housing 140 defining an inserting slot 122 and a cavity 124 communicating with the inserting slot 122. The receptacle 100 has a plurality of contact modules received in the cavity 124 and secured in the housing 140. The contact modules have a row of second contact modules 184 and a row of first contact modules 182 disposed in front of the row of second contact modules 184 at the inserting direction. The first contact modules 182 and the second contact modules 184 are arranged transversely in the housing 140 and have a certain pitch therebetween. Each of the second contact modules 184 has a second terminal 164 insert-molded with a second insulative wafer 174. Each of the first contact modules 182 has a first terminal 162 and a third terminal 166 insert-molded with a first insulative wafer 172. The first terminal 162 has a first contact portion 192, the second terminal 164 has a second contact portion 194, and the third terminal 166 has a third contact portion 196. The first contact portion 192 and the second contact portion 194 are disposed at the lower side of the inserting slot 122. The third contact portion 196 is disposed at the upper side of the inserting slot 122. The housing 140 has a protrusion 123 in front of the inserting slot 122, and the second terminals 164 are secured at the protrusion 123. As best shown in FIG. 7, the second contact portion 194 is lower than the first contact portion 192 at the direction perpendicular to the inserting direction. These terminals 162, 164, 166 also have a plurality of mounting portions 168 extending outwardly from the housing 140 shown in FIG. 2.

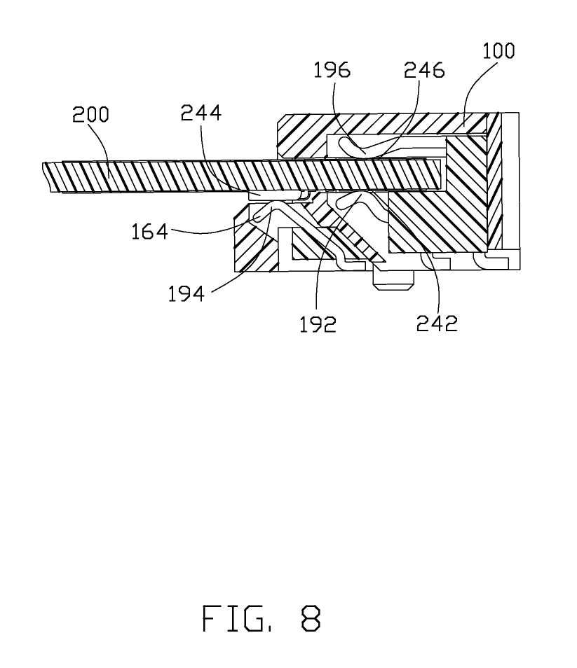

Referring to FIGS. 7-8, in assembling of the paddle board 200 to the receptacle 100. The paddle board 200 has a first height at the first conductive pads 242 and a second height at the second conductive pads 244. The first height is smaller than the distance between the second contact portions 194 and a top wall of the housing 140, therefore, the paddle board 200 is capable of inserting into the receptacle 100 without contacting with the second contact portions 194 until the second conductive pads 244 engaging with the second contact portions 194. The paddle board 200 could insert easily into the receptacle 100 and avoid undesired engagement between the second contact portions 194 and the paddle board 200.

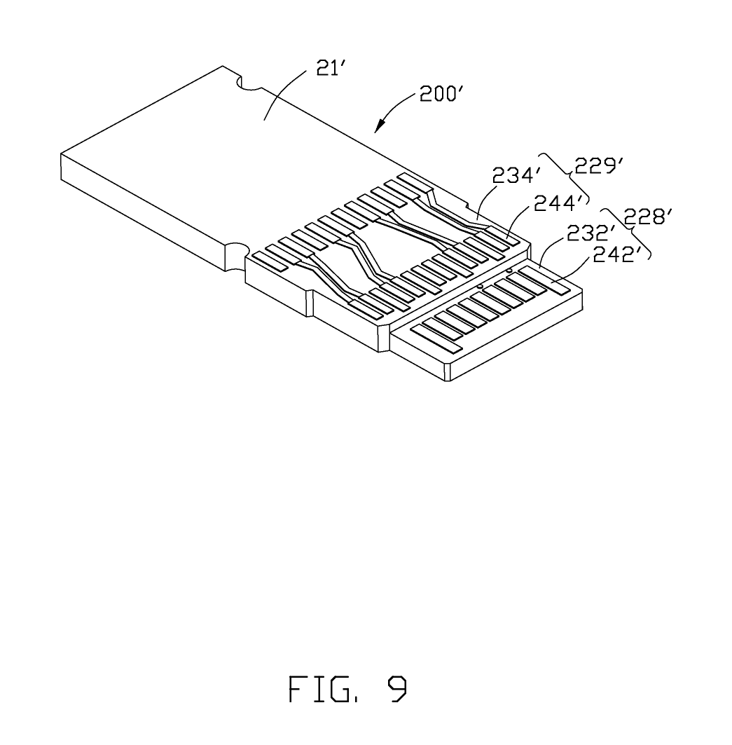

Referring to FIG. 9, it shows a paddle board 200′ of a second embodiment. The receptacle 100 and the second side 22 of paddle board 200 are same to that of the first embodiment. A row of first conductive pads 242′ are separated from each other by a first insulative layer 232′. A row of second conductive pads 244′ are separated from each other by a second insulative layer 234′. The first conductive pads 242′ and the first insulative layer 232′ are disposed at the a first mating face 228′. The second conductive pads 242′ and the second insulative layer 232′ are disposed at the a second mating face 229′. The second embodiment is different from the first embodiment in that the second mating face 229′ is higher than the first mating face 228′ on the first side 21′. The second conductive pads 244′ have a thickness similar to that of the first conductive pads 242′. The second conductive pads 244′ are higher than the first conductive pads 242′ along the direction from the second side to the first side 21′.

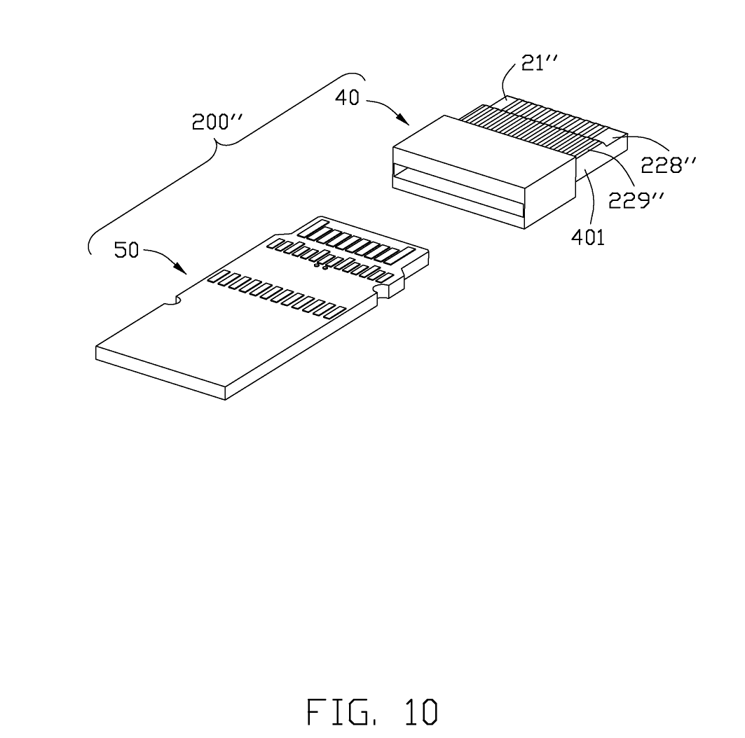

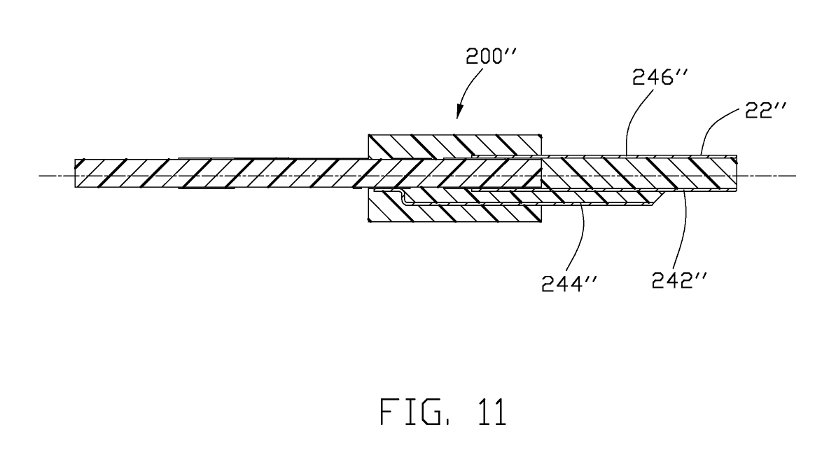

Referring to FIGS. 10-11, it shows a paddle board 200″ of a third embodiment. The paddle board 200″ includes an adapter 40 and a circuit board 50 inserted into the adapter 40. The adapter 40 includes an insulative housing 401 and three rows of pins 242″, 244″, 246″ insert-molded with the housing 401 and exposed to air. The adapter 40 has a first mating face 228″ and a second mating face 229″ higher than the first mating face 228″. The pins 242″, 244″, 246″ referred in the third embodiment are arranged like the conductive pads 242′, 244′, 246′ referred in the second embodiment. The pins 242″, 244″, 246″ include a row of first pin 242″ and a row of second pins 244″ disposed at a first side 21′ of the adapter 40. The pins 242″, 244″, 246″ also include a row of third pin 246″ disposed at a second side 22′ of the adapter 40. The second conductive pins 244″ are higher than the first conductive pins 242″ along the direction from the second side 22″ to the first side 21″. The circuit board 50 has a plurality of pads electrically connected to the pins 242″, 244″, 246″. When the paddle board 200″ is mated to the receptacle 100, the electrical connection between receptacle 100 and the paddle board 200″ is pins-to-pins resulting in an impedance matching better than the electrical connection of pads-to-pins referred in the first and the second embodiments.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the members in which the appended claims are expressed.

What is claimed is:

1. A receptacle connector adapted for inserting a plug connector having a paddle board along an inserting direction, comprising:
a housing defining an inserting slot and a cavity communicating with the inserting slot;
a row of first terminals disposed in the cavity, each of the first terminals having a first contact portion for mating with the paddle board;
a row of second terminals disposed in the cavity, each of the second terminals having a second contact portion for mating with the paddle board; and
wherein the first contact portions and the second contact portions are disposed at a first side of the inserting slot, the first contact portions being disposed in front of the second contact portions along the inserting direction and leveled higher than the second contact portions at another direction perpendicular to the inserting direction.

2. The receptacle connector as claimed in claim 1, wherein each of the second terminals is insert-molded with a second wafer to form a second contact module, and the second contact modules are arranged transversely in the housing.

3. The receptacle connector as claimed in claim 2, further comprising a row of third terminals disposed at a second side opposite to the first side of the inserting slot, each of the third terminals having a third contact portion for mating with the paddle board.

4. The receptacle connector as claimed in claim 3, wherein each of the first terminals and each of the third terminals are insert-molded with a first wafer to form a first contact module, and the first contact modules are arranged transversely in the housing.

5. The receptacle connector as claimed in claim 4, wherein the first contact modules and the second contact modules are disposed in two rows and are distanced a predetermined pitch.

6. The receptacle connector as claimed in claim 1, wherein said housing has a protrusion in front of the inserting slot, the second terminal being located at the protrusion.

7. A plug connector adapted for inserting in a receptacle connector along an inserting direction, comprising:
a paddle board having a first side, a second side and a mating edge;
a row of first conductive members and a row of second conductive members being arranged at the first side, the first conductive members being closer to the mating edge than the second conductive members;
wherein the second conductive members are higher than the first conductive members along a direction from the second side to the first side.

8. The plug connector as claimed in claim 7, wherein said paddle board has a first mating face and a second mating face disposed at the first side, the first conductive members being constituted of conductive pads arranged in the first mating face, the second conductive members being constituted of conductive pads arranged in the second mating face.

9. The plug connector as claimed in claim 8, wherein said second mating face is higher than the first mating face along the direction from the second side to the first side.

10. The plug connector as claimed in claim 8, wherein said second conductive pads are thicker than the first conductive pads.

11. The plug connector as claimed in claim 7, wherein said paddle board comprises an adapter and a circuit board inserted in the adapter, said adapter having a first mating face adjacent to the mating edge and a second mating face behind the first mating face, the first mating face and the second mating face being disposed at the first side of the adapter, the first conductive members being constituted of pins inserted-molded in the first mating face, the second conductive members being constituted of pins inserted-molded in the second mating face, and the second mating face is higher than the first mating face along the direction from the second side to the first side.

12. The plug connector as claimed in claim 7, wherein said paddle board has two rows of pads electrically connected to the row of first and the row of second conductive members respectively.

13. An electrical connector for receiving a printed circuit board unit defining first ands second rows of conductive pads thereon, comprising:
an insulative housing unit defining an elongated slot, for receiving the printed circuit board unit, along a first direction and communicating with an exterior in a second direction perpendicular to said direction;
a row of first contacts for corresponding to the first row of conductive pads, disposed by one side of the slot along said first direction with resilient first contacting sections extending into the slot in a third direction perpendicular to the first direction and the second direction; and
a row of second contacts for corresponding to the second row of conductive pads, disposed by said side of the slot along said first direction and inside of the row of the first contacts in said second direction with second resilient contacting sections extending into the slot in third direction; wherein
the second contacting sections extend into the slot beyond the first contacting sections along the third direction.

14. The electrical connector as claimed in claim 13, wherein the housing unit defines a first supporting face defining and confronting a first region of the slot around the first contacting sections, beyond which the first contacting sections extend in the third direction, and a second supporting face defining and confronting a second region of the slot around the second contacting sections and inside of the first region of the slot in the second direction, beyond which the second contacting sections extend in the third direction, under condition that the second face is closer to the other side of the slot than the first face.

15. The electrical connector as claimed in claim 13, wherein the first contacts are integrally formed with a plurality of first wafers stacked with one another in the first direction, and the housing unit defines a cavity to receive said first wafers therein.

16. The electrical connector as claimed in claim 13, wherein the second contacts are integrally formed with a plurality of second wafers stacked with one anther in the first direction, and the housing unit defines a cavity to receive said second wafers therein.

17. The electrical connector as claimed in claim 13, wherein the first contacts are discrete from the second contacts without mechanical deflection interrelationship therebetween.

18. The electrical connector as claimed in claim 13, wherein the conductive pads corresponding to the first contacts are thicker than those corresponding to the second contacts.

19. The electrical connector as claimed in claim 13, wherein the printed circuit board defines a first thickness corresponding to the first contacts, and a second thickness corresponding to the second contacts, under condition that the first thickness is larger than the second thickness.

20. The electrical connector as claimed in claim 13, wherein the printed circuit board unit includes a stepped adaptor in a front portion, on which said first and second rows of conductive pads are formed in a stepped manner.
